(19) United States
(12) Patent Application Publication
(10) Pub. No.: US 2007/0240019 A1
(43) Pub. Date: Oct. 11, 2007

(54) Systems and methods for correcting errors in I2C bus communications

(75) Inventors: Patrick D. Brady, Austin, TX (US); Daniel E. Hurlimann, Austin, TX (US); Vinh B. Lu, Austin, TX (US); Kirby L. Watson, Austin, TX (US); Lee H. Wilson, Austin, TX (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/321,621

(22) Filed: Dec. 29, 2005

(51) Int. Cl. G06F 11/00; G06F 13/00

(52) U.S. Cl. 714/43; 710/110

(57) ABSTRACT

Systems, methods and media for clearing a hung I2C bus are disclosed. In one embodiment, a monitor monitors the I2C bus data and clock lines and detects if a hung bus occurs. The monitor times packet transactions on the bus to determine if a maximum transaction time has elapsed while the lines are in a hung state. The monitor allows selective reset of individual slave devices and bus masters to clear a hung bus.

### FIELD

The present invention is in the field of digital system reliability and health monitoring. More particularly, the invention relates to clearing a hung bus and resetting slave devices on an I2C bus.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, and accounting. Further, networks enable high speed communication between people in diverse locations by way of e-mail, websites, instant messaging, and web-conferencing.

At the heart of each computer and server in a network is a microprocessor capable of executing computer instructions. These instructions are executed in execution units adapted to execute specific instructions. In a superscalar architecture, these execution units typically comprise load/store units, integer Arithmetic/Logic Units, floating point Arithmetic/Logic Units, and Graphical Logic Units that operate in parallel. In a processor architecture, an operating system controls operation of the processor and components peripheral to the processor. Executable application programs are stored in a computer's hard drive. The computer's processor causes application programs to run in response to user inputs.

Today, millions communicate and exchange information by way of computers connected to the Internet. Through the Internet, websites enable a user to access Website pages posted by other users, institutions, manufacturing companies, service providers, news media, etc. Search engines, such as those provided by Yahoo and Google, enable a user to search out information covering any topic under the sun by use of keywords. Internet Service Providers (ISPs) provide dozens or hundreds of servers to enable untold numbers of users to communicate by way of the web. These servers are interconnected and exhibit redundancy so that if one server fails, one or more others are assigned to take its place. Thus, a large number of servers are in operation and must be maintained.

Clearly, to monitor and maintain a system of hundreds of servers, an electronic system within the servers must be provided to provide monitoring and control of the servers electronic infrastructure (power quality, temperature, error handling, controlling LEDs for service personnel, etc.). This is done by controlling and monitoring devices such as Light Emitting Diodes (LEDs), temperature sensors, and fans. Other such devices may include memory, power regulators, and Input/Output (I/O) slots. A very popular and cost effective way of connecting these devices is by way of an Inter-Integrated Circuit (I2C) bus. The I2C bus provides a simple cost effective method for interfacing with the different electronic devices connected there to. The I2C bus comprises two active lines. The active lines are a bidirectional series data line Sda, and a bidirectional serial clock line. Every device linked to the I2C bus has a unique address and can act as a receiver and/or transmitter. Many devices can be connected to a single I2C bus. To communicate with a device on the bus, the bus master typically sends a start (or repeated start) condition, a 7-bit slave-address, followed by a data-direction bit. In response, the device, whose address was driven to the bus, sends a receiver-acknowledge bit. Following the receiver-acknowledge bit, the master (in the case of a write) or slave (in the case of a read) sends one or more data-byte transfers, each followed by a receiver-acknowledge bit. The communication is then terminated with a stop condition.

There are usually many I2C devices in a server. Electrical wiring considerations, I2C interrupt latency issues and I2C bus performance issues result in servers spreading all their I2C devices across several separate I2C buses. A baseboard management controller (BMC) connected to all of these I2C buses is provided within a server to perform system monitoring and maintenance functions. For example, the BMC will read a temperature value from a temperature sensor. If the temperature exceeds a pre-specified value, the BMC may cause a fan to turn on or to rotate faster to move more heat away from internal components of the server. As another example, the BMC may detect a faulty regulator voltage and in response, light an LED to indicate this condition. The BMC may also detect errors in memory or in an I/O adapter. I2C devices can be either masters or slaves. Some slave devices may send an interrupt signal to the BMC when the device has new information to provided to the BMC. Slave devices which do not provide interrupts have registers which can be polled by the BMC to determine if they have new information to provide. For example, the BMC may poll a power regulator to determine how much power that regulator is providing to the system.

Thus, typically the I2C system provides for environmental control, health monitoring, error detection, power management, and system vital product data acquisition. An I2C specification specifies how multiple bus masters and slaves can be connected to the same I2C bus and interoperate in a reliable fashion. Practical experience, however, shows that I2C busses are subject to a wide variety of hang conditions. These hangs most typically result from various issues arising from the switching of I2C buses with I2C multiplexer devices and I2C devices entering bad logic states causing them to fail to complete I2C transactions and thus hang the I2C bus in states from which further bus operations cannot proceed. When a bus hang occurs the bus must be cleared. Presently, this requires a reset of all the I2C devices on all of the I2C buses attached to the BMC and a reset of the BMC itself. A better way to handle I2C bus hang conditions is needed.

### SUMMARY

The problems identified above are in large part addressed by systems, methods and media for monitoring and resetting I2C bus devices as disclosed herein. One embodiment is an I2C bus monitor, comprising circuitry to monitor the state of the lines of an I2C bus. The monitor also comprises circuitry to selectively reset individual slave devices connected to the I2C bus and to reset bus masters connected to the I2C bus. A timing mechanism determines a maximum transaction period. Additional circuitry determines if a hung bus condition has occurred during the maximum transaction period. A hung bus condition occurs if during the entire maximum transaction period, the I2C bus remains at a steady state and the data line and clock line of the I2C bus are not both equal to one. A hung bus condition also occurs if, after an I2C start condition occurs, an I2C restart or an I2C stop does not occur during the entire maximum transaction period. The monitor may further comprise circuitry to receive signals from a baseboard management controller to enable software control of the monitor to selectively reset slave devices and bus masters.

Embodiments include servers with an I2C bus system, comprising a bus monitor to monitor the data line and clock line of the I2C bus and to detect if the bus is hung. The monitor individually resets slave devices connected to the I2C bus. The server further comprises a baseboard management controller to monitor and control slave devices and to instruct the bus monitor to selectively reset individual slave devices connected to the I2C bus. The bus monitor may further comprise a time out register providing a number to time a maximum transaction period. The monitor detects a hung bus if during the entire maximum transaction period, the I2C bus remains at a steady state and the data line and clock line of the I2C bus are not both equal to one. Or the monitor may also detect a hung bus if, after an I2C start condition occurs, an I2C restart or an I2C stop does not occur during the entire maximum transaction period. The monitor may further comprise a reset register with each bit of the reset register connected to a line connected to a different slave device or master to selectively reset the slave device or master.

Embodiments further include a method and system for detecting and correcting a hung I2C bus, comprising monitoring the state of the lines of the I2C bus. The system times a packet transaction on the bus and determines if a maximum transaction time has elapsed. A hung bus is declared if a hung bus condition applies at the end of the maximum transaction time. The system determines which slaves of the I2C bus and which masters of the I2C bus to reset in order to correct the hung bus condition. The system then resets the slaves and bus masters so determined. The method may further comprise receiving signals from a baseboard management controller to enable software control of the process to selectively reset slave devices and bus masters.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a server within a network; within the server is a baseboard management controller, I2C monitors, I2C masters and slaves.

FIG. 1A depicts a block diagram of an embodiment of multiple servers exercising I2C functions and reporting to a remote operator.

FIG. 2A depicts a deadlock monitor in communication with and I2C bus.

FIG. 2B depicts a baseboard management controller and a monitor in communication with an I2C bus.

FIG. 2 depicts an embodiment of a processor that may be configured to perform baseboard management control functions.

FIG. 3 depicts a flowchart of an embodiment for performing monitoring and resetting of an I2C bus.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for clearing a hung I2C bus are disclosed. In one embodiment, a monitor monitors the I2C bus data and clock lines and detects if a hung bus occurs. The monitor times packet transactions on the bus to determine if a maximum transaction time has elapsed while the lines are in a hung state. The monitor allows selective reset of individual slave devices and bus masters to clear a hung bus.

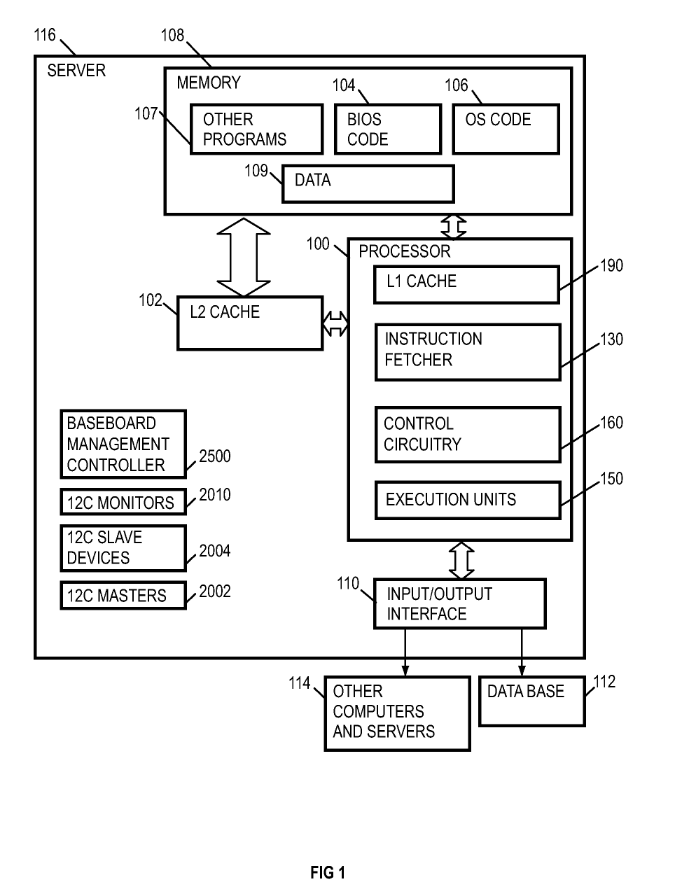

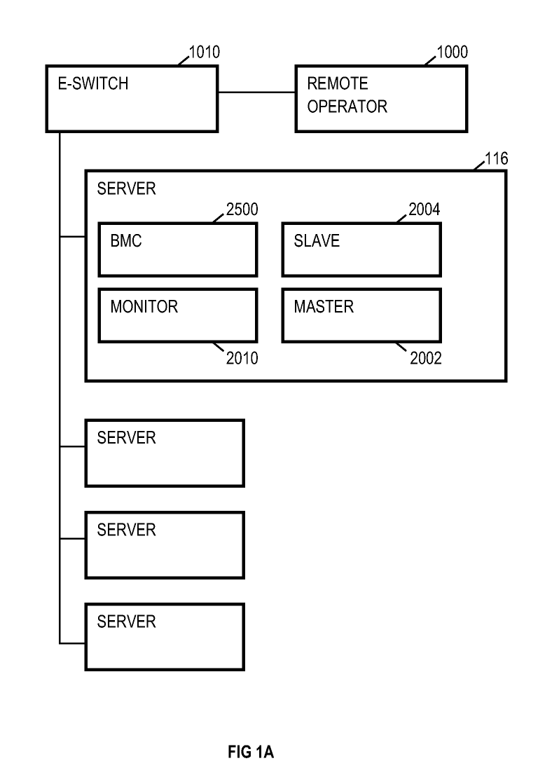

The present invention is discussed with reference to a server and a system of servers. However, the invention is not so limited. The invention may be implemented in an I2C system in any of a number of different systems that employ I2C. As an example, then, FIG. 1 shows a server 116 implemented according to one embodiment of the present invention with I2C components. Server 116 has a processor 100 that operates according to BIOS (Basis Input/Output System) Code 104 and Operating System (OS) Code 106. The BIOS and OS code is stored in memory 108. The BIOS code is typically stored on Read-Only Memory (ROM) and the OS code is typically stored on the hard drive of system 116. Server 116 also comprises a baseboard management controller 2500, I2C monitors 2010, bus masters 2002, and I2C slave devices 2004.

Server 116 comprises a level 2 (L2) cache 102 located physically close to processor 100 and to baseboard management controller (BMC) 2500. Memory 108 stores programs for execution by processor 100 and further stores a baseboard management control program for execution by BMC 2500. Thus, in an embodiment, memory 108 stores computer code to perform baseboard management control functions, as will be described herein. Processor 100 comprises an on-chip level one (L1) cache 190, an instruction fetcher 130, control circuitry 160, and execution units 150. Level 1 cache 190 receives and stores instructions that are near to time of execution. In processor 100, an instruction fetcher 130 fetches instructions from memory. Execution units 150 perform the operations called for by the instructions. Execution units 150 comprise stages to perform steps in the execution of the instructions fetched by instruction fetcher 130. Control circuitry 160 controls instruction fetcher 130 and execution units 150. Control circuitry 160 also receives information relevant to control decisions from execution units 150.

Server 116 also typically includes other components and subsystems not shown, such as: a Trusted Platform Module, memory controllers, random access memory (RAM), peripheral drivers, a system monitor, a keyboard, a color video monitor, one or more floppy diskette drives, one or more removable non-volatile media drives such as a fixed disk hard drive, CD and DVD drives, a pointing device such as a mouse, and a network interface adapter, etc. Server 116 may connect personal computers, workstations, servers, mainframe computers, notebook or laptop computers, desktop computers, or the like. Thus, processor 100 may also communicate with other servers and computers 114 by way of Input/Output Device 110. Thus, server 116 may be in a network of computers such as the Internet and/or a local intranet. Further, server 116 may access a database 112 and other memory comprising tape drive storage, hard disk arrays, RAM, ROM, etc.

In one mode of operation of server 116, the L2 cache 102 receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache. Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. Data processed by execution units 150 are storable in and accessible from integer register files and floating point register files (not shown.) Data stored in these register files can also come from or be transferred to on-board L1 cache 190 or an external cache or memory.

Server 116 also comprises a baseboard management controller 2500, as well as I2C monitors 2010, bus masters 2002, and I2C slave devices 2004. Baseboard management controller (BMC) 2500 is a processor that operates independently of processor 100. BMC 2500 controls and communicates with the I2C slave devices 2004 and bus masters 2002. The slave devices comprise components such as Light Emitting Diodes (LEDs), temperature sensors, and fans. Other slave devices may include memory, power regulators, and Input/Output (I/O) slots. Each bus master and slave has its own unique address. Multiple masters can be wired to the same I2C bus. The I2C standard provides a means for them to arbitrate for the control of the bus. The master that detects that it has lost arbitration for the bus terminates its transaction immediately without driving the bus any further and waits for the bus to go idle before attempting its transaction again.

BMC 2500 will execute a variety of functions. For example, BMC 2500 will read a temperature value from a temperature sensor. If the temperature exceeds a pre-specified value, BMC 2500 may cause a fan to turn on or to rotate faster to move more heat away from internal components of the server. As another example, BMC 2500 may detect a faulty regulator voltage and in response, light an LED to indicate this condition. BMC 2500 may also detect errors in memory or in an I/O slot, for example. Some slave devices may send an interrupt signal to BMC 2500 when an error in such a slave device occurs. Also, BMC 2500 can poll an internal register of each of a plurality of slave devices to determine what errors, if any, exist. For example, BMC 2500 may poll a power regulator to determine if the power regulator is not outputting a proper voltage.

I2C monitors 2010 are a plurality of monitors, each one monitoring a different I2C bus. In one embodiment, a server may have as many as 10 different I2C buses, each with its own monitor, masters, and slaves. Thus, each one of a plurality of I2C busses is connected to one or more bus masters 2002 slave devices 2004. All I2C devices can be classified as a master or slave. A master is a device that initiates a message. A slave is a device that responds to a message initiated by the master. Thus, slave devices may include a plurality of devices that can be addressed and written to by a bus master.

In the course of system operation, an I2C bus may become hung. A hung bus arises when an event that should occur in the course of transferring data between a bus master and a slave device fails to occur or when an event occurs that should not occur. For example, a bus may be hung because a slave fails to deliver to a bus master a stop character. Each monitor 2010 may detect if its bus is a hung bus. Monitor 2010 allows a certain amount of time to transpire before a hung bus is declared. This amount of time can be specified by the programming in the BMC. Thus, a monitor 2010 monitors the lines of the I2C bus to which it is connected to determine if a bus is hung. In response to detection of a hung bus, monitor 2010 may issue a reset signal to each of one or more particular slave devices and also may issue a reset signal to each one of one or more bus masters.

FIG. 1A shows a network of servers 116 that may be monitored by a remote operator 1000. Remote operator 1000 is connected to the various servers 116 by way of an Ethernet switch 1010. Servers 116 are connected to a network of computers and to each other by way of bus lines 1020. By way of an I2C system, as will be explained herein, remote operator 1000 can monitor the health of the system of servers 116 and can issue commands to the servers. The I2C system receives information from temperature sensors and sends on/off signals to Light Emitting Diodes (LEDs). Also, the I2C system monitors status bits of various slave devices within the servers. These status bits indicate the state of the respective slave device. For example, the system may monitor a plurality of power supply regulators to determine if a power regulator is faulty. If, for example, a power supply regulator of a server is faulty, the system may transfer communications of the faulty server to another server with an operational power supply. The system thus provides power management and system health monitoring.

Thus, each server comprises a baseboard management controller (BMC) 2500, at least one monitor 2010 to monitor an I2C bus to which it is connected and at least one other slave device 2004 connected to the I2C bus. Remote operator 1000 can therefore monitor the state of various devices throughout the system of servers 116. To this end, remote operator 1000 may typically comprise a computer with a processor, a video monitor, a keyboard and mouse. This enables a human being to interact with the system by observing and altering the state of the system. Remote operator 1010 may cause Ethernet switch 1010 to select any one of a plurality of servers that are connected to Ethernet switch 1010. Each of the servers may be selected successively to learn the state of the entire system of servers 116. In addition to monitoring the status of devices, remote operator 1010 may, for example, initiate a power on sequence or a power off sequence of a server.

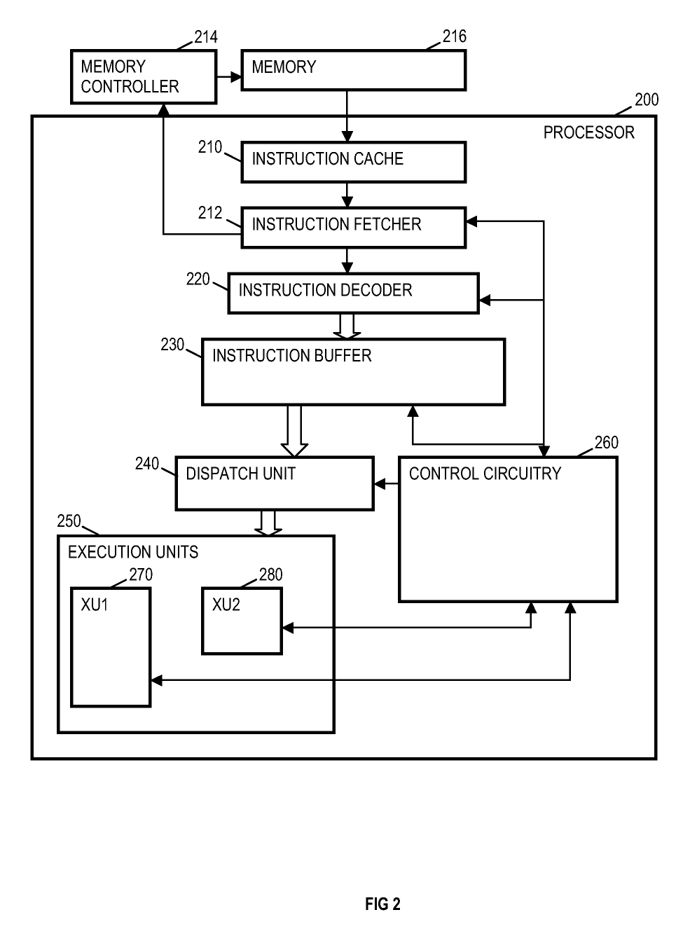

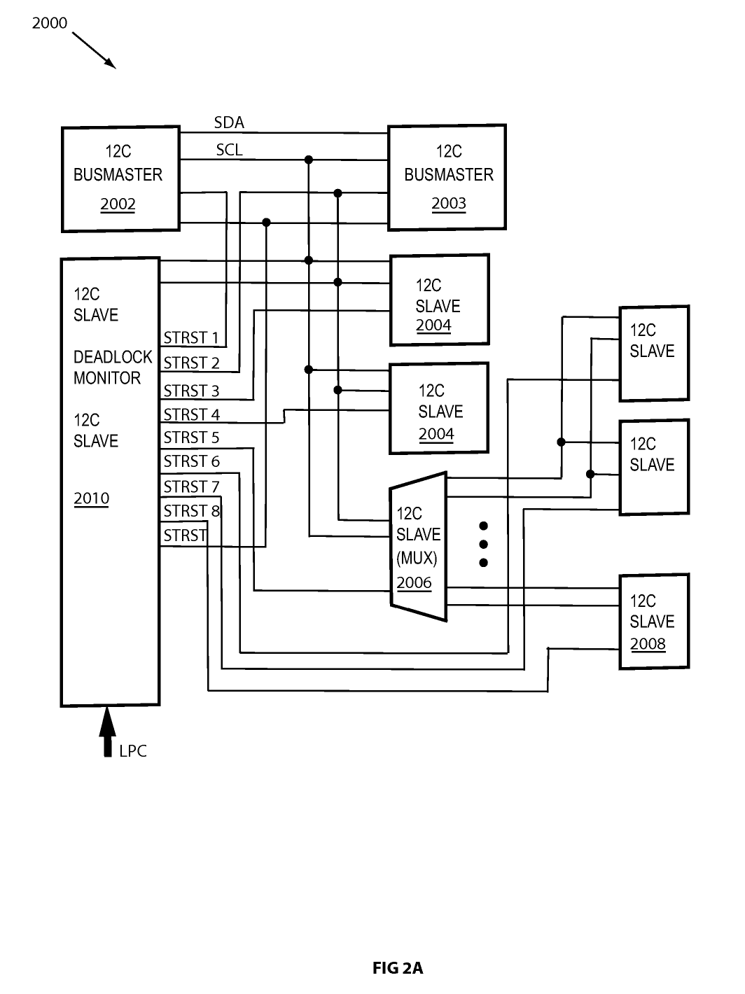

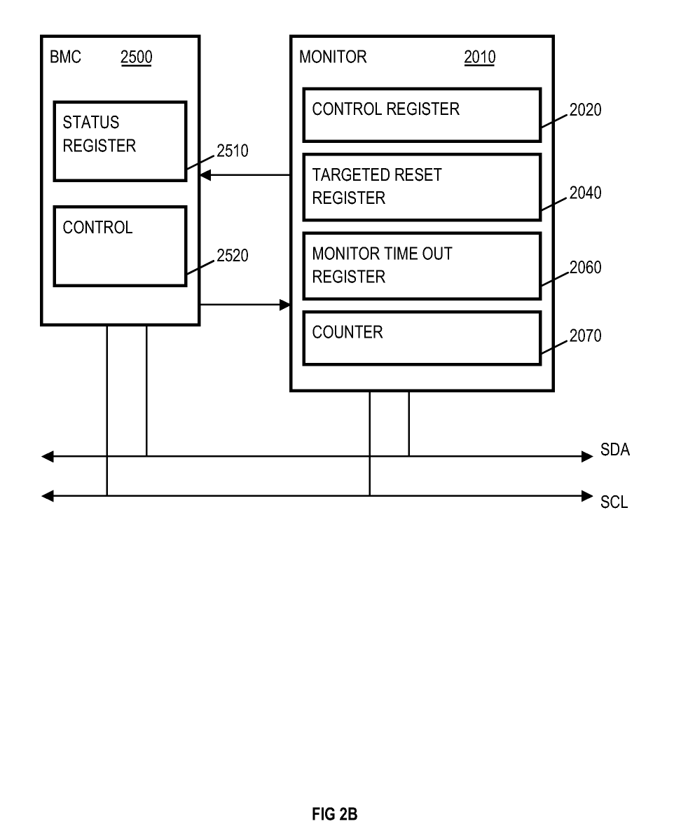

FIG. 2A shows an I2C system 2000 within a server such as server 116. I2C system 2000 comprises a plurality of I2C bus masters 2002. Each bus master is connected to two architected lines: a data line, Sda, and a clock line, Scl. These lines are connected to a plurality of I2C slaves 2004, including an I2C multiplexer 2006 that connects a plurality of I2C slaves 2008 to the bus lines. Thus, data can be asserted onto the bus and a clock line is provided to clock the data into or out of a slave device. In a write cycle, wherein a bus master writes data to a slave device, the bus master will assert an address on the data line Sda. Each connected slave will receive this address. When a slave receives the address, it determines whether the received address matches its own internal address. If it does, the slave must assert an address acknowledgement signal to the bus master. The bus master may then write data to the slave using the SDA and SCL lines. For each byte of data it successfully receives, the slave asserts an acknowledgment signal to the bus master. The bus master releases control of the bus when it has sent all the intended data using a stop signal. In a read cycle, wherein a bus master reads data from a slave device, the bus master will assert an address using the SDA and SCL lines. Each connected slave will receive this address. When a slave receives the address, it determines whether the received address matches its own internal address. If so, the slave must assert an address acknowledgement signal and provide data bits or acknowledgement bits on the SDA line for each clock pulse the master asserts on the SCL line. The master asserts the stop character returning the I2C bus to an idle state after it has finished reading all the data it desires.

A bus line may become “locked”, “stuck”, or “hung” for several reasons. One example is where an electrical condition on the bus (such as a circuit card with the I2C pull up resistors is absent) or a device on the bus holds the bus in a state such that the I2C stop signal either is not sent or cannot be sent. Another example would be that an I2C slave tries to throttle the speed of a transaction by holding the state of the SCL line but ultimately does not resolve the situation that caused it to throttle the speed and leaves the bus permanently stuck. As another example, a device might be in a bad state holding either sda or scl to zero thus prohibiting the bus from ever entering an idle state so more transactions can proceed. Accordingly, a deadlock monitor 2010 monitors the lines Sda and Scl to determine if the bus is in a hung state. Deadlock monitor 2010 can be simply implemented using a Programmable Logic Device (PLD). If a monitor 2010 determines that an I2C bus is hung, it may issue a reset signal Srst to reset a slave device 2004, 2006, 2008, or a bus master 2002, 2003, or both.

FIG. 2A shows these reset lines labeled Srst1 through Srst8. Thus, in response to certain signals on the lines Sda and Scl, deadlock monitor 2010 can reset a particular device or set of devices and clear the bus. An I2C slave is reset by re-initializing its internal registers. Only the slave that is the source of the problem need be reset. A complete reset of all slaves including ones that have not hung the bus is usually unnecessary. Note also that the monitor may receive a Low Pin Count (LPC) connection from the BIOS of the server so that the BIOS may clear the bus if it suspects it has lost communication with system management functions. Thus, a monitor may operate under the control of the BIOS of the server and/or may operate under the control of a baseboard management controller.

Bus masters 2003 and 2004 also receive from the monitor, a single shared bus master resynchronization line carrying a signal (referred to herein as a BRST signal). The BRST signal will restart all the bus masters on a given I2C bus. Note that this is not the same as a complete reset of all systems management functions in the server. Rather, the bus master implementer may choose to retry operations en-queued in hardware after a BRST signal occurs. Thus, the BRST signal brings the bus masters to an initial state from which execution of their functions may continue as before the bus hang up.

Note that monitor 2010 and multiplexer 2006 are on a main I2C radial. This way, potential hangs on all sub-radials can be resolved with only one deadlock monitor. If a sub radial is hung, then resetting multiplexer 2006 by way of its SRST line will disconnect the offending radial and allow the main radial to resume normal operation. Software executed by a baseboard management controller, as discussed below, should avoid reconnecting sub radials that continually hang the I2C bus after a reset.

FIG. 2B shows a Base board Management Controller (BMC) 2500 which is a processor that executes instructions to perform power management and health monitoring functions. BMC 2500 interfaces with monitor 2010. Both the BMC and the monitor are connected to the bus lines. Monitor 2010 monitors the lines Sda and Scl and can send the reset signals to slave devices and bus masters as described above. Monitor 2010 informs BMC 2500 when a bus is hung. BMC 2500 communicates with the monitor 2010 to determine which I2C bus is hung. BMC software knows the system I2C topology and can then determine what resets it wants to perform using the monitor 2010. Thus, BMC 2500 may maintain a status register to receive and store the state of a slave device and an indication whether the bus is hung. BMC 2500 exercises a control function 2520 to instruct the monitor to reset a slave device or to restart the bus masters. BMC 2500 also performs functions to control the various slave devices connected to the bus. These functions include changing the on/off state of an LED, reading a temperature sensor, and controlling the state of more complex slave devices.

Monitor 2010 comprises three registers: a control register 2020, a targeted reset register 2040, and a monitor timeout register 2060. The control register 2020 has 8 bits that can be set individually. The control register 2020 has an enable monitor bit 7 that enables monitoring when the bit is set and disables monitoring when the bit is not set. The BMC will set this bit according to a program for control and monitoring of the system health. The monitor will normally be enabled. Control register 2020 also has a bus master reset bit 6. This bit is normally unasserted and will toggle when asserted. That is, when the BMC asserts this bit in the monitor, it will be communicated as a pulse to the bus masters on the I²C bus. The pulse is of relatively short duration, just long enough to ensure reset of the bus masters. The remaining bits of control register 2020 may be used for other functions or may be unused.

Targeted reset register 2040 comprises bits, each bit corresponding to a different slave device. When BMC 2500 asserts a bit of targeted reset register 2040, the slave corresponding to the bit is reset. The size of this register will be dictated by the number of separate I2C resets the system designer desires for the monitored I2C bus. For instance, an 8 bit register can hold bits corresponding to 8 different slave devices, inclusive of multiplexers, if individual resets are desired for each device. Thus, the bits of targeted reset register 2040 are normally unasserted. Monitor 2010 communicates the status of the bus to BMC 2500. BMC 2500 determines from its knowledge of the various I2C devices on the affected bus what action to take, if any. This may include resetting the state of a slave device to a known initial state. From this initial state, BMC 2500 can bring the slave device to any other desired state.

Monitor time out register 2060 comprises a binary value equal to a number of time out units to allow a bus to remain hung before it informs the BMC 2500. The value of the time out unit is set in the monitor hardware. For example, the time out unit can be set to 4 milli-seconds and the binary value equal to the number of time out units before a hung bus will be declared can be set equivalent to decimal 128. This results in a delay of 512 milliseconds during which the bus may become hung. At the end of 512 milliseconds, if the bus is hung, BMC 2500 will be informed and normally it would reset the affected slave devices and busmasters by asserting the SRST lines of the slave devices and asserting the BRST line. At the end of the time out period the monitor will declare the bus hung if either one of the following two conditions apply:
1) The I²C bus remains at a steady state other than Sda=1 and Scl=1 for the entire time out period; or
2) An I²C start condition occurs and an I²C restart or an I²C stop does not occur within the time out period.

Monitor 2010 comprises a counter 2070 which is reset whenever the I2C bus returns to an idle state (sda=1 and scl=1) after a valid stop character or a bus restart occurs. If the BMC 2500 caused the monitor 2010 to perform I2C resets, the monitor resets counter 2070.

FIG. 2 shows an embodiment of a processor 200 that can be implemented in a server such as server 116 to execute baseboard management control software as described herein. The processor 200 of FIG. 2 is configured to execute baseboard management control instructions to provide the functionality described with respect to BMC 2500. In one embodiment, processor 200 is a relatively simple programmable 8 bit processor or microcontroller. A level 1 instruction cache 210 receives baseboard management control instructions from memory 216 external to the processor, such as level 2 cache. Thus, baseboard management control software may be stored in memory 108 as an application program. Groups of sequential instructions of the BMC software can be transferred to the L2 cache, and subgroups of these instructions can be transferred to the L1 cache 210.

An instruction fetcher 212 maintains a program counter and fetches baseboard management control instructions from L1 instruction cache 210. The program counter of instruction fetcher 212 comprises an address of a next instruction to be executed. Instruction fetcher 212 may also perform pre-fetch operations. Thus, instruction fetcher 212 communicates with a memory controller 214 to initiate a transfer of baseboard management control instructions from a memory 216 to instruction cache 210. The place in the cache to where an instruction is transferred from system memory 216 is determined by an index obtained from the system memory address.

Sequences of instructions are transferred from system memory 216 to instruction cache 210 to implement baseboard management control functions. For example, a sequence of instructions may instruct processor 200 to load from the monitor into a processor register, the value of an indicator whether the bus is hung. The instructions further instruct processor 200 to send signals to the registers of monitors 2010. Thus, in one instance, processor 200 will send an enable signal to the control register of a monitor to enable detection of bus conditions. If the monitor indicates to the processor that the bus is hung, processor 200 may cause the monitor to send SRST signals to reset the slave devices and a BRST signal to reset the bus masters. Software also instructs processor 200 to read temperature monitors and the state of other slave devices. Software may further instruct processor 200 to send signals to light LEDs, for example, or to set slave devices to a different state, or to change the speed of a fan.

Instruction fetcher 212 retrieves the baseboard management control instructions passed to instruction cache 210 and passes them to an instruction decoder 220. Instruction decoder 220 receives and decodes the instructions fetched by instruction fetcher 212. Instruction buffer 230 receives the decoded instructions from instruction decoder 220. Instruction buffer 230 comprises memory locations for a plurality of instructions. Instruction buffer 230 may reorder the order of execution of instructions received from instruction decoder 220. Instruction buffer 230 therefore comprises an instruction queue to provide an order in which instructions are sent to a dispatch unit 240.

Dispatch unit 240 dispatches baseboard management control instructions received from instruction buffer 230 to execution units 250. Execution units 250 may comprise load/store units, integer Arithmetic/Logic Units, floating point Arithmetic/Logic Units, and Graphical Logic Units, all operating in parallel. Dispatch unit 240 therefore dispatches instructions to some or all of the executions units to execute the instructions simultaneously. Execution units 250 comprise stages to perform steps in the execution of instructions received from dispatch unit 240. Data processed by execution units 250 are storable in and accessible from integer register files and floating point register files not shown. Thus, instructions are executed sequentially and in parallel.

FIG. 2 shows a first execution unit (XU1) 270 and a second execution unit (XU2) 280 of a processor with a plurality of execution units. Each stage of each of execution units 250 is capable of performing a step in the execution of a different baseboard management control instruction. In each cycle of operation of processor 200, execution of an instruction progresses to the next stage through the processor pipeline within execution units 250. Those skilled in the art will recognize that the stages of a processor “pipeline” may include other stages and circuitry not shown in FIG. 2. Moreover, by multi-thread processing, multiple baseboard management control processes may run concurrently. For example, by executing instructions of different threads, the processor may load and evaluate a bus hang indicator from the deadlock monitor while contemporaneously performing other I2C functions such as incrementing a number of times the bus is hung. Thus, a plurality of instructions may be executed in sequence and in parallel to perform baseboard management control functions.

FIG. 2 also shows control circuitry 260 to perform a variety of functions that control the operation of processor 200. For example, an operation controller within control circuitry 260 interprets the OPCode contained in an instruction and directs the appropriate execution unit to perform the indicated operation. Also, control circuitry 260 may comprise a branch redirect unit to redirect instruction fetcher 212 when a branch is determined to have been mispredicted. Control circuitry 260 may further comprise a flush controller to flush instructions younger than a mispredicted branch instruction. Branch instructions may arise from performing any one of a plurality of baseboard management control functions. For example, determining if a hung bus is declared involves a branch instruction. If a hung bus is declared, then a sequence of instructions is executed to clear the bus. If a hung bus is not declared, then operation continues normally. Control logic for executing these and other branch instructions is thus provided by control circuitry 260.

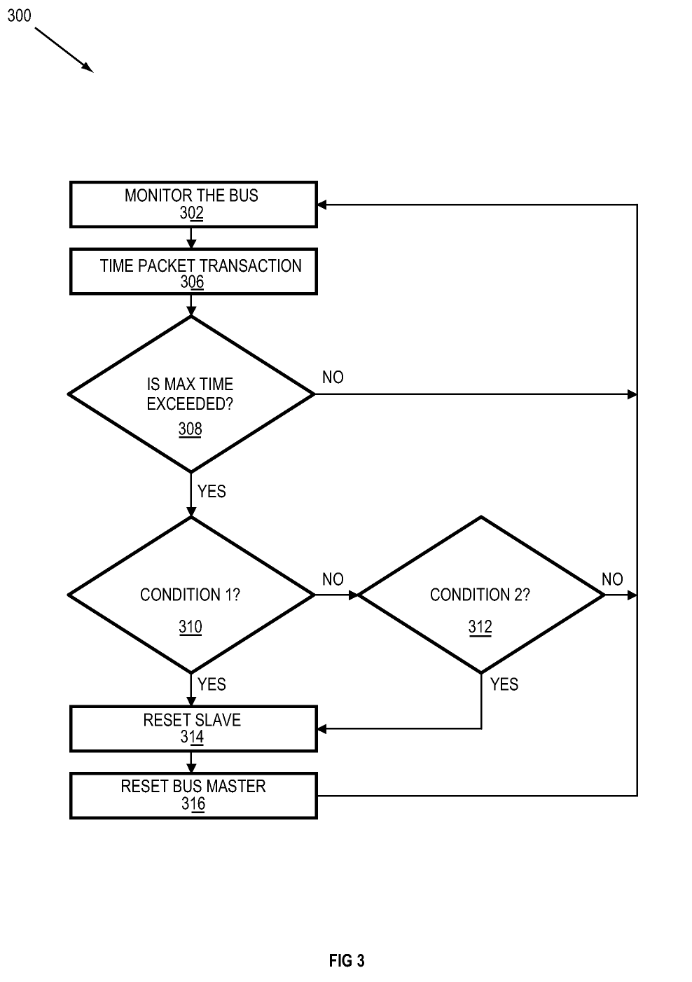

FIG. 3 shows a flow chart 300 of an embodiment for monitoring and clearing bus hang ups. In normal operation, the bus monitor of an I2C bus will monitor the Sda and Scl lines of the I2C bus (element 302). The monitor can detect, for example, when a bus remains at steady state other than Sda=1 and Scl=1. For example, the monitor will detect if the lines are in the condition: Sda=0 and Scl=0. The monitor can also detect when an I2C start condition occurs and an I2C restart or an I2C stop does not occur. Contemporaneously with monitoring the bus, the system times a packet transaction between a bus master and a slave (element 306). A specified time unit is stored in the hardware of the monitor and a user-specified number is stored in the monitor time out register. The maximum transaction period is the specified time unit times the number in the time out register. When a transaction starts, the monitor begins timing the transaction and will continue to time the transaction while the monitor continues to monitor the bus, until the maximum transaction period is exceeded.

Until the maximum transaction period is exceeded (element 308), the monitor continues to monitor for conditions 1 or 2 above. If the maximum transaction period is exceeded (element 308), the monitor determines if condition 1 applies (element 310). That is: has the I2C bus remained at steady state (other than Sda=1, Scl=1) for the entire maximum transaction period. If condition 1 applies (element 310), the baseboard management controller will attempt to clear the bus by resetting the slaves (element 314) and busmasters (element 316) as necessary. If condition 1 does not apply (element 310), then the monitor determines if condition 2 applies (element 312). That is, has an I2C start condition occurred without an I2C restart or an I2C stop during the maximum transaction period. If condition 2 applies (element 310), the baseboard management controller will attempt to clear the bus by resetting the slaves (element 314) and busmasters (element 316) as necessary. Any successful I2C bus transaction that occurs within the maximum transaction period should cause the I2C bus to return to an idle state (sda=1 and scl=1) after a stop signal). Monitoring stops during the I2C bus idle state and begins again when the next I2C bus transaction starts.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An Inter-Integrated Circuit (I2C) bus monitor, comprising:
circuitry to monitor the state of the lines of an I2C bus;
circuitry to selectively reset individual slave devices connected to the I2C bus and to reset bus masters connected to the I2C bus;
a timing mechanism for determining a maximum transaction period; and
circuitry to determine if a hung bus condition has occurred during the maximum transaction period.

2. The monitor of claim 1, wherein a hung bus condition occurs if during the entire maximum transaction period, the I2C bus remains at a steady state and the data line and clock line of the I2C bus are not both equal to one.

3. The monitor of claim 1, wherein a hung bus condition occurs if, after an I2C start condition occurs, an I2C restart or an I2C stop does not occur during the entire maximum transaction period.

4. The monitor of claim 1, further comprising circuitry to receive signals from a baseboard management controller to enable software control of the monitor to selectively reset slave devices and bus masters.

5. The monitor of claim 4, further comprising circuitry to communicate from the monitor to the baseboard management controller the state of the bus.

6. The monitor of claim 1, further comprising a Low Pin Count (LPC) input of the monitor from a Basic Input Output System (BIOS) of a server that comprises the monitor.

7. The monitor of claim 1, further comprising a reset register with each bit of the reset register connected to a line connected to a different slave device or master to selectively reset the slave device or master.

8. The monitor of claim 1, further comprising a time out register containing a number of fundamental time units to time the maximum transaction period.

9. A method for detecting and correcting a hung Inter-Integrated Circuit (I2C) bus, comprising:
monitoring the state of the lines of the I2C bus;
timing a packet transaction on the bus and determining if a maximum transaction time has elapsed;
declaring a hung bus if a hung bus condition applies at the end of the maximum transaction time;
determining which of a plurality of slaves of the I2C bus to reset in order to correct the hung bus condition; and
resetting the determined slaves.

10. The method of claim 9, wherein a hung bus condition occurs if during the entire maximum transaction period, the I2C bus remains at a steady state and the data line and clock line of the I2C bus are not both equal to one.

11. The method of claim 9, wherein a hung bus condition occurs if, after an I2C start condition occurs, an I2C restart or an I2C stop does not occur during the entire maximum transaction period.

12. The method of claim 9, further comprising receiving signals from a baseboard management controller to enable software control of the process to selectively reset slave devices.

13. The method of claim 9, further comprising a reset register with each bit of the reset register connected to a line connected to a different slave device or master to selectively reset the slave device or master.

14. The method of claim 9, further comprising a time out register containing a number of fundamental time units to time the maximum transaction period.

15. A server with an Inter-Integrated Circuit (I2C) bus system, comprising:
a bus monitor to monitor the data line and clock line of the I2C bus and to detect if the bus is hung and to individually reset slave devices connected to the I2C bus; and
a baseboard management controller to monitor and control slave devices and to instruct the bus monitor to selectively reset individual slave devices connected to the I2C bus.

16. The server of claim 15, wherein the bus monitor comprises a time out register providing a number to time a maximum transaction period.

17. The server of claim 16, wherein a hung bus is detected if during the entire maximum transaction period, the I2C bus remains at a steady state and the data line and clock line of the I2C bus are not both equal to one.

18. The system of claim 16, wherein a hung bus is detected if, after an I2C start condition occurs, an I2C restart or an I2C stop does not occur during the entire maximum transaction period.

19. The server of claim 15, further comprising a time out monitor to determine if a hung bus condition exists.

20. The server of claim 15, further comprising a reset register with each bit of the reset register connected to a line connected to a different slave device or master to selectively reset the slave device or master.
